(19) United States
(12) Patent Application Publication
(10) Pub. No.: US 2018/0341016 A1
(43) Pub. Date: Nov. 29, 2018

(54) SURROUNDINGS MONITORING DEVICE

(71) Applicant: HONDA MOTOR CO., LTD., Tokyo (JP)

(72) Inventors: Takahiro Ohmoto, Wako-shi (JP); Yoshihiro Urai, Wako-shi (JP); Makoto Aimura, Wako-shi (JP); Hiroyuki Midorikawa, Wako-shi (JP); Isao Tomita, Wako-shi (JP)

(21) Appl. No.: 15/980,925

(22) Filed: May 16, 2018

(30) Foreign Application Priority Data
May 23, 2017 (JP) 2017-101842

(51) Int. Cl. G01S 13/93; G01S 13/86

(52) U.S. Cl. CPC G01S 13/931; G01S 2013/9389; G01S 2013/9357; G01S 13/86

(57) ABSTRACT

A surroundings monitoring device (100) includes an object detection unit (110) which is mounted in a structure and detects objects around the structure, a first sensor (120) for determining whether an object has collided with the structure, and a first controller (140) which determines whether the object has collided with the structure on the basis of the detection result of the first sensor and restrains the operation of the object detection unit or causes an information output unit to output predetermined information in a case that it is determined that the object has collided with the structure.

### CROSS-REFERENCE TO RELATED APPLICATION

Priority is claimed on Japanese Patent Application No. 2017-101842, filed May 23, 2017, the content of which is incorporated herein by reference.

### BACKGROUND OF THE INVENTION

### Field of the Invention

The present invention relates to a surroundings monitoring device.

### Description of Related Art

There is a technology for detecting objects around a vehicle using a radar device and estimating a collision between an object and the vehicle on the basis of the detection result (e.g., Japanese Unexamined Patent Application, First Publication No. 2005-165752).

### SUMMARY OF THE INVENTION

The conventional technology does not consider small-scale collisions which cannot be detected by a radar device. Accordingly, an occupant may not recognize that the radar device is not in its original state.

An object of the present invention devised in view of the aforementioned circumstances is to provide a surroundings monitoring device capable of detecting a small-scale collision with high accuracy.

The surroundings monitoring device according to the present invention employs the following configuration.
(1) A surroundings monitoring device according to an embodiment of the present invention includes: an object detection unit which is mounted in a structure and detects objects around the structure; a first sensor for determining whether an object has collided with the structure; and a first controller which determines whether the object has collided with the structure on the basis of the detection result of the first sensor and restrains the operation of the object detection unit or causes an information output unit to output predetermined information in a case that it is determined that the object has collided with the structure.
(2) In the embodiment (1), the structure is a vehicle, and the first sensor is used as a sensor for determining whether a hood of the vehicle is lifted in a hood driving device including a driving unit which drives the hood of the vehicle such that the hood is lifted, and a second controller which controls the driving unit.
(3) In the embodiment (2), the first sensor detects the magnitude of the scale of a collision stepwise or in continuous values, the first controller restrains the operation of the object detection unit or causes the information output unit to output the predetermined information in a case that the magnitude of the scale of a collision detected by the first sensor exceeds a first threshold value, the second controller operates the driving unit in a case that the magnitude of the scale of the collision detected by the first sensor exceeds a second threshold value, and the first threshold value is smaller than the second threshold value.
(4) In the embodiment (1), the first sensor is arranged away from the object detection unit in a detection direction of the object detection unit.
(5) In the embodiment (1), the first sensor is arranged in proximity to the object detection unit.
(6) In the embodiment (1), the first sensor is arranged above the object detection unit.

According to the above-described embodiment (1), it is possible to accurately determine a small-scale collision between the structure and the object to improve reliability of detection of an object.

According to the above-described embodiment (2), it is possible to simplify a device configuration by the surrounding monitoring device and the hood driving device sharing the first sensor.

According to the above-described embodiment (3), it is possible to advise inspection of the vehicle even in a case that a collision of a degree that does not cause the hood driving device to operate occurs.

According to the above-described embodiment (4), a collision with the first sensor occurs before a collision with the object detection unit occurs, and thus it is possible to display advice for checking a failure, an axial deviation and the like of the object detection unit caused by the collision.

According to the above-described embodiment (5), since the object detection unit and the first sensor are arranged in proximity to each other, the object detection unit is estimated to also be affected by a collision in a case that an external force is applied to the first sensor, and thus it is possible to perform control of retraining the operation of the object detection unit or display for advising inspection of the object detection unit.

According to the above-described embodiment (6), in a case that an external force is applied to the first sensor disposed above the object detection unit, it is estimated that a force causing axial deviation is applied to the object detection unit and thus it is possible to perform control of retraining the operation of the object detection unit or display for advising inspection of the object detection unit.

### BRIEF DESCRIPTION OF THE DRAWINGS

FIG. 1 is a diagram showing an example of a configuration of a vehicle control system including a surroundings monitoring device of an embodiment.

FIG. 2 is a plan view showing a positional relationship between an object detection unit and a first sensor in a vehicle of an embodiment.

FIG. 3 is a side view (cross-sectional view) showing the positional relationship between the object detection unit and the first sensor in the vehicle of an embodiment.

FIG. 4 is a diagram showing an example of an image displayed on an information output unit of an embodiment.

FIG. 5 is a diagram showing an example of a device configuration of a hood driving device of an embodiment.

FIG. 6 is a side view (cross-sectional view) showing a positional relationship between the object detection unit and the first sensor of an embodiment in a case that a collision occurs.

FIG. 7 is a diagram showing an example of a configuration of a surroundings monitoring device of an embodiment.

FIG. 8 is a diagram showing an example of a configuration of a second sensor of an embodiment.

### DETAILED DESCRIPTION OF THE INVENTION

Hereinafter, embodiments of a surroundings monitoring device of the present invention will be described with reference to the drawings.

### First Embodiment

### [Vehicle Control System]

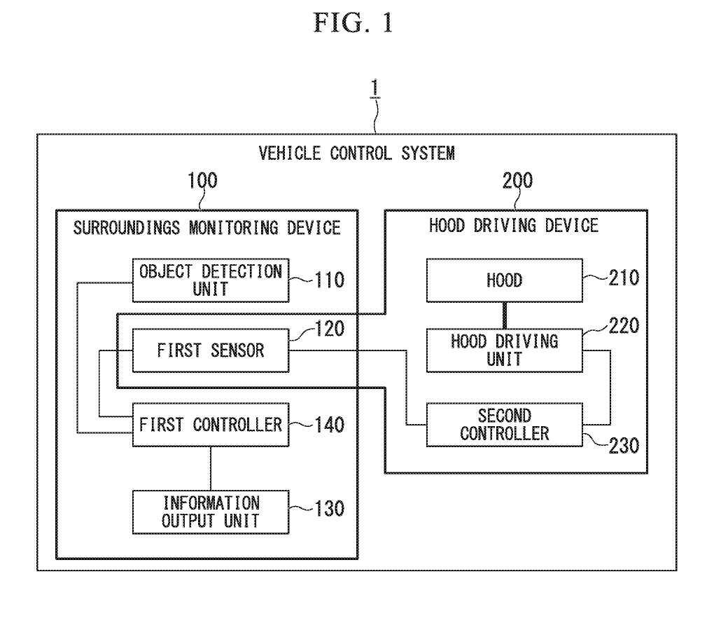

FIG. 1 is a diagram showing an example of a configuration of a vehicle control system 1 including a surroundings monitoring device 100. For example, the vehicle control system 1 includes the surroundings monitoring device 100 and a hood driving device 200. The surroundings monitoring device 100 is mounted in a structure (e.g., a vehicle M) and outputs an alarm to a vehicle occupant or indicates automatic brake control on the basis of a detection result detected by an object detection unit 110. The hood driving device 200 pops up a hood 210 depending on the magnitude of the scale of a collision with an object, detected by a first sensor 120, to improve the cushioning property of the hood 210. Although the vehicle M is a vehicle having four or more wheels, for example, it may be another type of vehicles.

### [Surroundings Monitoring Device]

For example, the surroundings monitoring device 100 includes the object detection unit 110, the first sensor 120, a first controller 140 and an information output unit 130. The object detection unit 110 is a millimeter-wave radar, for example. The object detection unit 110 detects an object using a frequency modulated continuous wave (FM-CW), for example. Accordingly, the object detection unit 110 detects a detection target which is moving or still within a distance range of about one hundred meters. The object detection unit 110 may be a camera rather than the radar device.

The first sensor 120 is a sensor for determining whether an object has actually collided with the vehicle M. For example, the first sensor 120 is an acceleration sensor. The first sensor 120 detects a magnitude of acceleration which can be regarded as a magnitude of the scale of a collision in continuous values. The first sensor 120 may detect a magnitude of acceleration stepwise (e.g., step values such as large, medium and small) by being provided along with a comparator. A detected value of the first sensor 120 is also input to a hood driving unit 220 which will be described later.

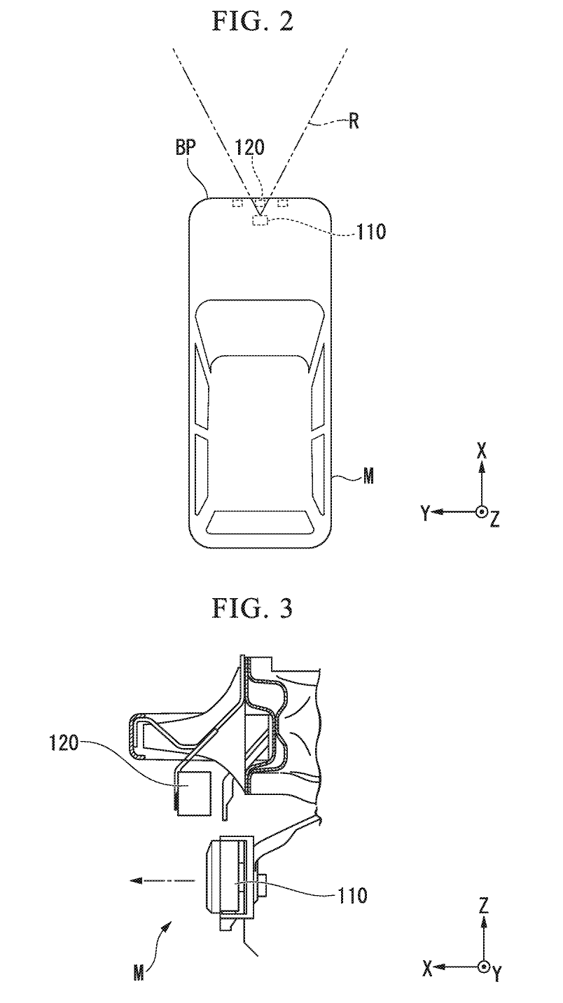

FIG. 2 is a plan view showing a positional relationship between the object detection unit 110 and the first sensor 120 in the vehicle M. The object detection unit 110 is provided on the front side of the vehicle M, for example, and detects objects around the vehicle M. The object detection unit 110 radiates a probe beam R in a detection direction (e.g., a forward direction of the vehicle M), detects reflected waves from an object and detects the object on the basis of the detected reflected waves.

For example, the first sensor 120 is disposed inside of a bumper BP of the vehicle M. The first sensor 120 is arranged in the detection direction (+X direction) of the object detection unit 110 and separated from the object detection unit 110. A plurality of first sensors 120 may be provided. In a case that a collision with the vehicle M occurs, as will be described later, the first sensor 120 is affected by the collision before the object detection unit 110 is affected by the collision according to the above-described positional relationship of the first sensor 120.

FIG. 3 is a side view (cross-sectional view) showing the positional relationship between the object detection unit 110 and the first sensor 120 in the vehicle M. For example, the first sensor 120 is disposed at a position separated from the object detection unit 110 in front of thereof (+X direction). The first sensor 120 and the object detection unit 110 are arranged close to each other and thus, in a case that an external force is applied to the first sensor 120, the object detection unit 110 is estimated to also be affected.

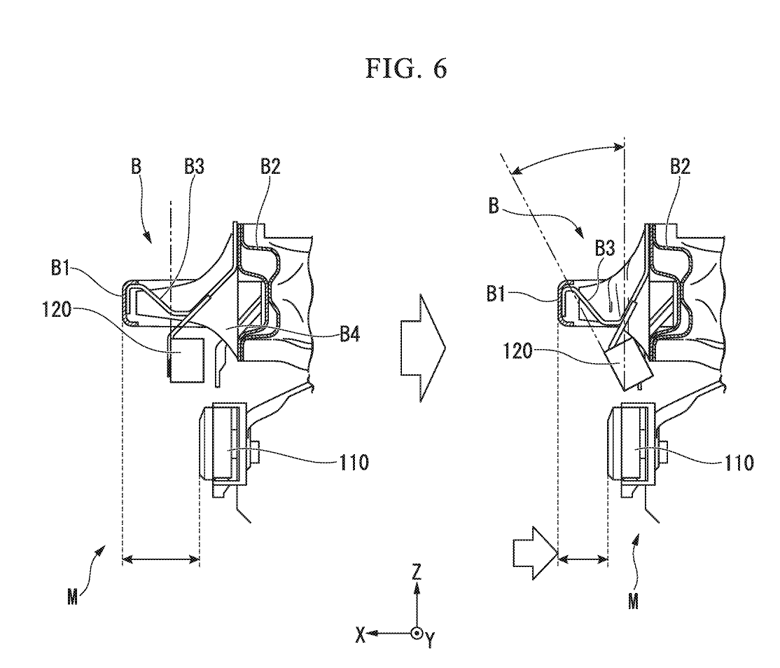

For example, the first sensor 120 is disposed above the object detection unit 110 (+Z direction). Since the first sensor 120 is disposed above the object detection unit 110, in a case that an external force is applied to the first sensor 120, a diagonally downward force is estimated to be applied to the object detection unit 110 (refer to FIG. 6). In a case that the diagonally downward force is applied, the detection direction of the object detection unit 110 may deviate (so-called axial deviation). This is not a desirable state. The object detection unit 110 may suffer mechanical damage due to a collision with a surrounding apparatus or structure in addition to the axial deviation.

The information output unit 130 is a display device, for example. The information output unit 130 may include a speaker. The information output unit 130 outputs various types of information. The information output unit 130 may be a display device of a navigation system (not shown).

The first controller 140 is connected to the object detection unit 110, the first sensor 120 and the information output unit 130. For example, the first controller 140 is realized by executing a program (software) through a processor such as a central processing unit (CPU). This functional unit may be realized by hardware such as large scale integration (LSI), an application specific integrated circuit (ASIC) and a field-programmable gate array (FPGA) or may be realized by cooperation of software and hardware.

For example, the first controller 140 causes the information output unit 130 to output predetermined information in a case that it is determined that an object has collided with the vehicle M or it is estimated that the object will collide with the vehicle M soon on the basis of a detection result of the object detection unit 110. The predetermined information is an alarm indicating occurrence of a collision or a display advising inspection, for example. The information output unit 130 may output sound or voice in addition to displaying the predetermined information.

Here, in a case that an object collides with the first sensor 120, the object detection unit 110 may have a failure or axial deviation, as described above. Accordingly, the first controller 140 determines whether an object has collided with the vehicle M on the basis of a detection result of the first sensor 120. For example, the first controller 140 determines that an object has collided with the vehicle M in a case that the detection result of the first sensor 120 exceeds a first threshold value.

In a case that it is determined that the object has collided with the vehicle M, the first controller 140 restrains the operation of the object detection unit 110. The first controller 140 restrains the operation of the object detection unit 110 by stopping power supply to the object detection unit 110 or increasing the threshold value for the detection result of the object detection unit 110.

In a case that it is determined that the object has collided with the vehicle M, the first controller 140 causes the information output unit 130 to display a screen for advising inspection of the first sensor 120.

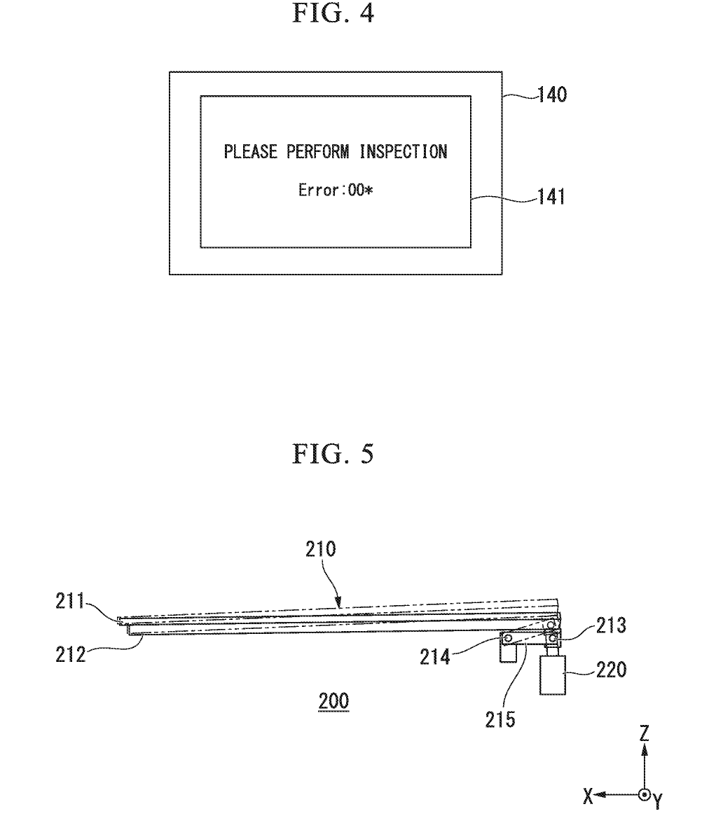

FIG. 4 is a diagram showing an example of an image 141 displayed through the information output unit 130. For example, the information output unit 130 displays a message advising a person riding in the vehicle M to inspect the vehicle M and an error code through the image 141. As the error code, different codes are displayed according to the scales of collisions. For example, inspection items associated with error codes are described in the manual of the vehicle M. A user inspects or repairs the vehicle M according to the error code. The aforementioned determination and display may be performed according to a failure diagnosis function provided in the vehicle M.

According to the surroundings monitoring device 100, the attachment state of the object detection unit 110 can be estimated on the basis of a result of determination of the magnitude of the scale of a collision. Accordingly, the surroundings monitoring device 100 can estimate presence or absence of mechanical damage of the object detection unit 110. The mechanical damage refers to a state in which a stress is applied to the object detection unit 110 due to an external factor generated in a case that the vehicle stops or travels that damages the object detection unit 110 and causes deterioration in the performance of the object detection unit 110. Damage of the object detection unit 110 includes damage such as axial deviation of an attachment part of the object detection unit 110 in addition to damage of the object detection unit 110 itself.

### [Hood Driving Device]

Referring back to FIG. 1, in a case that the vehicle M has collided with a pedestrian, for example, the hood driving device 200 lifts the rear end of the hood up to form a space between the hood and devices under the hood, such as an engine, thereby improving the cushioning property. For example, the hood driving device 200 includes the hood 210, the hood driving unit 220, the first sensor 120 and a second controller 230.

The hood driving device 200 shares the first sensor 120 with the surroundings monitoring device 100. The hood 210 is an openable exterior member for covering the engine mounted in the front nose of the vehicle M.

The second controller 230 is connected to the first sensor 120 and the hood driving unit 220. For example, the second controller 230 is realized by executing a program through a processor such as a CPU. This functional unit may be realized by hardware such as LSI, an ASIC and an FPGA or may be realized by software and hardware in cooperation. The second controller 230 may be integrated with the first controller 140 of the surroundings monitoring device 100.

The second controller 230 determines whether the vehicle M has collided with an object on the basis of a detection result of the first sensor 120. The second controller 230 determines that the vehicle M has collided with the object in a case that a detection value exceeds a second threshold value. The second controller 230 operates the hood driving unit 220 in a case that it is determined that the vehicle M has collided with the object. Here, the second threshold value is set to be equal to or greater than the first threshold value which causes the surroundings monitoring device 100 to operate

That is, the surroundings monitoring device 100 operates with a smaller scale of collision than a collision that causes the hood driving device 200 to operate. Accordingly, the surroundings monitoring device 100 can determine a collision with an object even in a case that such a collision originally does not cause various apparatuses to operate, to improve reliability with respect to object detection.

FIG. 5 is a diagram showing an example of a device configuration of the hood driving device 200. For example, the hood 210 is formed by attaching a plate 211 to a reinforcing frame 212. A first hinge 213 for opening/closing is provided at the rear end of the hood 210. A second hinge 214 for pop-up is provided in front of the first hinge 213. The first hinge 213 and the second hinge 214 are connected through a link plate 215.

For example, the hood driving unit 220 is an actuator which extends upward in a case that a collision occurs. The hood driving unit 220 is disposed under the rear end of the hood 210. The hood driving unit 220 extends according to control of the second controller 230 to lift the rear end of the hood 210 in a case that a collision is detected.

### [Inspection of Vehicle]

Next, inspection of a vehicle in a case that a collision with the vehicle occurs will be described. FIG. 6 is a side view (cross-sectional view) showing a positional relationship between the object detection unit 110 and the first sensor 120 in a case that a collision occurs. For example, the first sensor 120 is disposed in a pedestrian collision energy absorption member B provided inside the bumper BP of the vehicle M. The pedestrian collision energy absorption member B is installed at a height associated with the legs of pedestrians, for example.

The pedestrian collision energy absorption member B includes a first horizontal member B1 extending in a lateral direction in the horizontal direction inside the bumper BP (Y-axis direction), a second horizontal member B2 provided on the body side of the vehicle M opposite to the first horizontal member B1, and a plurality of brackets B3 and B4 which connect the first horizontal member B1 and the second horizontal member B2. The first sensor 120 is attached to each of the plurality of brackets B3.

For example, a plurality of the brackets B3 and B4 are plate-shape bodies formed by being curved. The bracket B3 and the bracket B4 have different attachment angles and shapes. For example, the bracket B3 is attached in the horizontal direction. For example, the bracket B4 is attached in the vertical direction (Z-axis direction).

In a case that a collision occurs, a force in the horizontal direction is applied to the first horizontal member B1 toward the body of the vehicle M and thus a distance between the first horizontal member B1 and the second horizontal member B2 is reduced. Here, the plurality of brackets B3 and B4 are deformed such that the degree of curvature increases to absorb energy of the collision. The attachment position and attachment angle of the first sensor 120 vary according to deformation of the bracket B3.

In a case that the magnitude of the scale of a collision is significant, and thus even the object detection unit 110 is affected by the collision, attachment position deviation or axial deviation of the object detection unit 110 may occur or the object detection unit 110 may be damaged.

The magnitude of the scale of a collision is determined by the first controller 140, and the information output unit 130 displays the image 141 depending on the magnitude of the scale of the collision, as described above. Then, the user performs inspection according to an error code depending on the magnitude of the scale of the collision displayed in the image 141.

According to the above-described surroundings monitoring device 100 of the first embodiment, a small-scale collision between the vehicle M and an object can be determined with high accuracy. As a result, reliability of detection of an object through the surroundings monitoring device 100 can be improved. According to the vehicle control system 1, the surroundings monitoring device 100 and the hood driving device 200 share the first sensor 120 and thus it is not necessary to provide a sensor in each of them, resulting in cost reduction.

### Second Embodiment

Although the first sensor 120 shared by the surroundings monitoring device 100 and the hood driving device 200 is used to detect a collision in the first embodiment, a different sensor is used to detect a collision in the second embodiment.

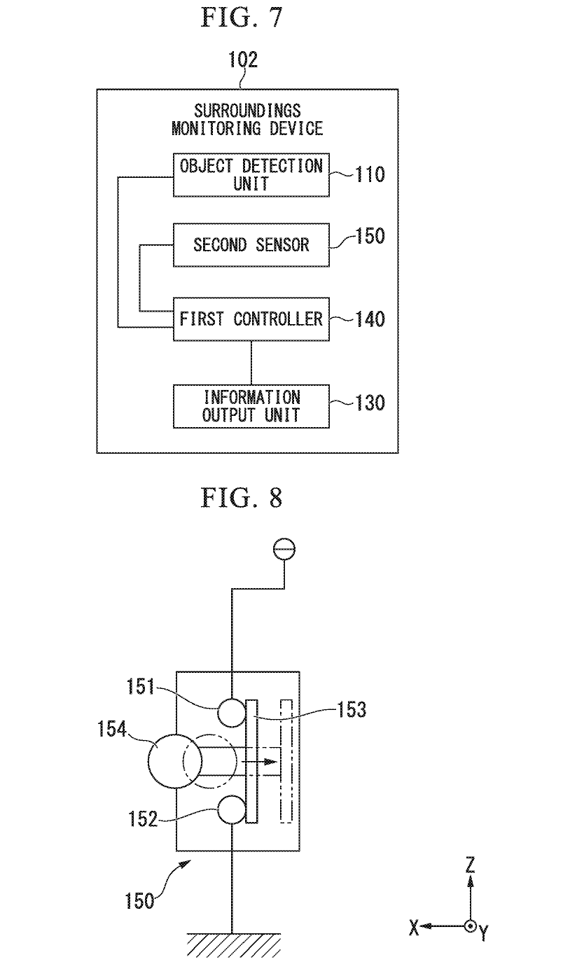

FIG. 7 is a diagram showing an example of a configuration of a surroundings monitoring device 102 according to the second embodiment. The surroundings monitoring device 102 includes a second sensor 150. For example, the second sensor 150 is provided in proximity to and in front of the object detection unit 110 of the vehicle M as in the first embodiment.

FIG. 8 is a diagram showing an example of a configuration of the second sensor 150. For example, the second sensor 150 is a latch switch. The second sensor 150 is in an on state (a conduction state or a closed state) in a case that an external force is not applied thereto and is in an off state (an interruption state or an open state) in a case that an external force is applied. The first controller 140 continuously applies a predetermined voltage to the second sensor 150 to detect application of an external force through interruption of current flow.

The second sensor 150 includes a first contact 151, a second contact 152, a conduction member 153 and a press member 154. The second sensor 150 turns on in a case that the conduction member 153 comes in contact with the first contact 151 and the second contact 152.

The conduction member 153 is connected to the press member 154. The press member 154 presses the conduction member 153 to separate the conduction member 153 from the first contact 151 and the second contact 152 such that the second sensor 150 turns on in a case that an external force is applied thereto. For example, application of an external force deforms a structure such as the bumper BP due to a collision to press the press member 154 in the −X direction. The first controller 140 determines whether an object has collided with the vehicle M on the basis of whether the second sensor 150 is in an on state or off state.

For example, in a case that the second sensor 150 is in an off state, the first controller 140 determines that the object has collided with the vehicle M. In this case, the first controller 140 restrains the operation of the object detection unit 110 or causes the information output unit 130 to output predetermined information.

According to the above-described surroundings monitoring device 102 of the second embodiment, it is possible to determine a smaller scale of collision between the vehicle M and an object with high accuracy as in the first embodiment. As a result, reliability of detection of an object through the surroundings monitoring device 100 can be improved.

While the present invention has been described in detail with reference to the embodiments thereof, the present invention is not limited to such embodiments and various changes and modifications may be made therein without departing from the spirit or scope of the present invention. For example, the above-described surroundings monitoring device may be mounted in a fixed or moving structure in addition to the vehicle M.

What is claimed is:

1. A surroundings monitoring device comprising:
an object detection unit which is mounted in a structure and detects objects around the structure;
a first sensor for determining whether an object has collided with the structure; and
a first controller which determines whether the object has collided with the structure on the basis of the detection result of the first sensor and restrains the operation of the object detection unit or causes an information output unit to output predetermined information in a case that it is determined that the object has collided with the structure.

2. The surroundings monitoring device according to claim 1, wherein the structure is a vehicle, and
the first sensor is used as a sensor for determining whether a hood of the vehicle is lifted in a hood driving device including a driving unit which drives the hood of the vehicle such that the hood is lifted, and a second controller which controls the driving unit.

3. The surroundings monitoring device according to claim 2, wherein the first sensor detects the magnitude of the scale of a collision stepwise or in continuous values,
the first controller restrains the operation of the object detection unit or causes the information output unit to output the predetermined information in a case that the magnitude of the scale of a collision detected by the first sensor exceeds a first threshold value,
the second controller operates the driving unit in a case that the magnitude of the scale of the collision detected by the first sensor exceeds a second threshold value, and
the first threshold value is smaller than the second threshold value.

4. The surroundings monitoring device according to claim 1, wherein the first sensor is arranged in a detection direction of the object detection unit and separated from the object detection unit.

5. The surroundings monitoring device according to claim 1, wherein the first sensor is arranged in proximity to the object detection unit.

6. The surroundings monitoring device according to claim 1, wherein the first sensor is arranged above the object detection unit.
